(19) United States
(12) Patent Application Publication
(10) Pub. No.: US 2026/0260144 A1
(43) Pub. Date: Sep. 3, 2026

(54) Quantum Mass Production for Classical Data Loading

(71) Applicant: Google LLC, Mountain View, CA (US)

(72) Inventors: William Huggins, Oakland, CA (US); Tanuj Khattar, Los Angeles, CA (US); Craig Gidney, Goleta, CA (US)

(21) Appl. No.: 19/552,347

(22) Filed: Feb. 27, 2026

Related U.S. Application Data
(60) Provisional application No. 63/765,446, filed on Feb. 28, 2025.

(51) Int. Cl. G06N 10/20; G06N 10/40

(52) U.S. Cl. CPC G06N 10/20; G06N 10/40

(57) ABSTRACT

Examples of the present disclosure are directed to a method for operating a quantum computing system (QCS) to load classical data. The method includes configuring a quantum circuit to implement a target classical function that is defined over a string of input bits. The target classical function is decomposed into a set of parity sub-functions. A set of quantum registers of the QCS is initialized with a superposition of input states corresponding to the string of input bits. A sequence of Quantum Read-Only Memory (QROM) operations is executed on the set of quantum registers to generate a set of outputs. Each QROM operation of the sequence of QROM operations encodes a separate parity sub-function of the set of parity sub-functions. Each output of the set of outputs is routed to a separate output register of a set of output registers of the QCS.

### PRIORITY

This application claims priority to the U.S. Provisional Application No 63/765,446 entitled QUANTUM MASS PRODUCTION FOR CLASSICAL DATA LOADING, filed on Feb. 28, 2025, the contents of which are herein incorporated in their entirety.

### FIELD

The present disclosure relates generally to quantum computing and information processing systems, and more particularly to efficiently loading classical data on a quantum computing system.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0 ,” quantum computing systems can manipulate information using quantum bits (“qubits”). A qubit can refer to a quantum device that enables the superposition of multiple states, e.g., data in both the “0 ” and “1” state, and/or to the superposition of data, itself, in the multiple states. In accordance with conventional terminology, the superposition of a “0 ” and “1” state in a quantum system may be represented, e.g., as a|0 [symbol] +b|1 [symbol] . The “0 ” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

In an aspect, examples of the present disclosure are directed to a method for operating a quantum computing system (QCS) to load classical data. The method includes configuring a quantum circuit to implement a target classical function that is defined over a string of input bits. The target classical function is decomposed into a set of parity sub-functions. A set of quantum registers of the QCS is initialized with a superposition of input states corresponding to the string of input bits. A sequence of Quantum Read-Only Memory (QROM) operations is executed on the set of quantum registers to generate a set of outputs. Each QROM operation of the sequence of QROM operations encodes a separate parity sub-function of the set of parity sub-functions. Each output of the set of outputs is routed to a separate output register of a set of output registers of the QCS.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a classical data loading pipeline, according to example embodiments of the present disclosure;

FIG. 2 depicts a flowchart of a method 200 for operating a quantum computing system (QCS) to load classical data, according to various embodiments; and

FIG. 3 provides a schematic representation of a quantum computing system, according to various embodiments.

### DETAILED DESCRIPTION

Many practical quantum algorithms involve processing large amounts of classical information. This task, often referred to as classical data loading, involves coherently transferring (or loading) classical data—such as tabular data, molecular information, or machine learning datasets—into a quantum computing system. Some approaches for loading this classical data frequently utilize Quantum Read-Only Memory (QROM) operations.

However, instantiating these approaches tends to be highly resource-intensive, utilizing very large quantum circuits with substantial numbers of quantum logic gates (such as Clifford and non-Clifford gates). Because quantum algorithms frequently execute data loading subroutines multiple times, whether sequentially or in parallel, the computational overhead of some approaches often dominates the overall cost and execution time of the quantum algorithm

The embodiments herein are directed to systems and methods for efficiently loading classical data. The embodiments described herein mitigate at least some of the computational resource costs associated with classical data loading by breaking the classical data loading operation into a series of smaller subproblems.

To perform classical data loading operations, some embodiments configure a quantum circuit to implementμ a target classical function f that is decomposed into a set of parity sub-functions G. These parity sub-functions represent the parity (e.g., the exclusive OR (XOR)) of different consecutive evaluations of the target classical function. Because the parity sub-functions act on a reduced number of input bits compared to the full target classical function, the quantum gate count for implementing each individual sub-function is substantially reduced.

In some embodiments, a quantum computing system (QCS) may execute a sequence of QROM operations to encode these separate parity sub-functions. During execution of the QROM operations, the QCS may route inputs and outputs to these sub-functions using a series of controlled swap gates conditioned on specific portions of the input bitstrings, such as a string of most significant bits. By recombining the outputs of these smaller sub-functions, the QCS provides parallel evaluations of the target classical function across multiple different inputs. This parallel loading technique enables executing the data loading subroutine multiple times in parallel for a computational cost that is less than or comparable to executing other approaches a single time, effectively providing a computational discount.

Additionally, the embodiments provide for accelerating serial data loading queries. First, the QCS may utilize a parallel loading technique (e.g., described throughout) to generate multiple copies of a resource state. The resource state may include a superposition of input states entangled with an output register containing evaluations of the target classical function. When the QCS consumes one of these resource states to perform a serial query, the query may yield a preliminary output corresponding to the target classical function exclusive ORed (XORed) with a random bitstring error.

To prepare the output, the QCS may apply a correction operation to remove the random bitstring error. This correction operation utilizes a correction function G(X) defined as the target classical function XORed with the incorrect lookup. Because this correction function may be a symmetric function with respect to the random bitstring error, it can be specified using less information than the target classical function. The correction operation may utilize approximately half the computational cost of evaluating the original target classical function, yielding significant efficiency gains even when operations are performed in series.

As noted above, loading classical data into a quantum computer involves large quantum circuits. For many practical applications of quantum computing, the slowest and most costly steps may involve coherently accessing this classical data. Some approaches to the data loading problem are challenging because quantum computers are expected to be slower and smaller than their classical counterparts. As a result, loading classical data may be a resource-intensive process that can act as a significant bottleneck.

The embodiments provide systems and methods to reduce the cost of classical data loading by subdividing the problem down into a series of smaller subproblems. By routing the inputs and outputs to these smaller subproblems, the embodiments can efficiently perform two queries for approximately the cost of a single query. Furthermore, a recursive construction allows the embodiments to reduce the overall cost when implementing many classical data loading steps in parallel. To assist with implementing serial data loading steps, several copies of a resource state can be prepared in parallel. The embodiments can then consume these resource states to implement the data loading operation up to a smaller correction.

More specifically, some embodiments decompose a target classical function into a set of parity sub-functions using a concatenation of bits. The first few bits of the target classical function may be fixed to to define ƒ_{L}(Z). The set of parity sub-functions, denoted as G, may be defined to represent the exclusive OR (XOR) or parity of two different ƒ functions. The parity sub-functions may reduce a complexity, as compared to the target classical function. For instance, there may be 2^{k+1} such G functions, and each is simpler than the target classical function by a factor of 2^{k} because they utilize fewer input bits. Furthermore, some embodiments may utilize multiple smaller data lookups (e.g., for the parity sub-functions) instead of one large data lookup (e.g., for the more complex target classical function). These lookups may rely on a quantum read-only memory (QROM) method that works in superposition. Some embodiments may employ serial operations and corrections. For serial operations, a resource state may be created and consumed, which results in the original function ƒ(x) being XORed with a random bitstring. These embodiments may correct this by loading data representing a function G(X), defined as the original ƒ(x) XORed with the incorrect lookup.

Some embodiments include a method for operating a QCS to load classical data. The method configures a quantum circuit to implement a target classical function that is defined over a string of input bits, wherein the target classical function is decomposed into a set of parity sub-functions. A set of quantum registers of the QCS is initialized with a superposition of input states corresponding to the string of input bits. A sequence of QROM operations is executed on the set of quantum registers to generate a set of outputs, wherein each QROM operation of the sequence of QROM operations encodes a separate parity sub-function of the set of parity sub-functions. Each output of the set of outputs is then routed to a separate output register of a set of output registers of the QCS.

The embodiments provide various technical effects. At least some embodiments provide a gate reduction. These embodiments may minimize the number of quantum gates utilized during data loading, including both Clifford and non-Clifford gates. Some embodiments provide for parallel execution efficiency. The data loading subroutine can be executed multiple times in parallel for a cost comparable to running it a single time. For example, two copies of the loading operation can be performed in parallel with nearly a 50% reduction in cost compared to running them separately. The embodiments may additionally provide for serial execution efficiency. Due to the symmetry of the function used in corrections, it can be specified with half as much information, reducing the cost of the correction to half that of the original implementation.

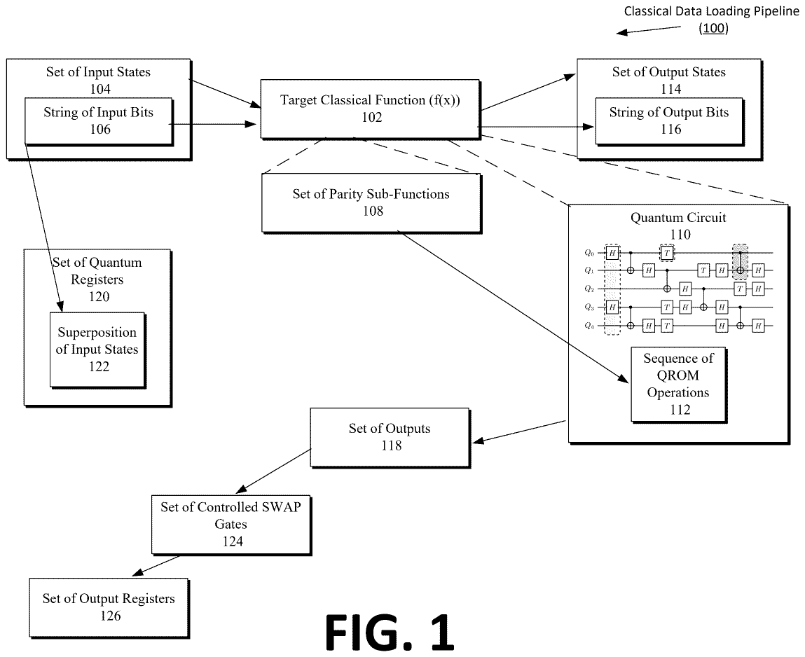

FIG. 1 depicts a classical data loading pipeline 100, according to example embodiments of the present disclosure. In the classical data loading pipeline 100, a quantum computing system (QCS) can be operated to load classical data. A target classical function 102 is shown in FIG. 1. As used herein, the term “target classical function” may be used to refer to any mathematical, logical, or algorithmic mapping, relation, operation, or data structure associating an input bitstring or data set with a corresponding output bitstring or data set. Examples of target classical functions include, but are not limited to, Boolean functions, data sets for quantum algorithms utilizing a linear combination of unitaries (LCU) formalism, coefficients for a state preparation subroutine, and data representing a quantum chemical Hamiltonian in a second quantization representation.

The domain of the classical target function 102 is a set of input states 104 and the range of the target classical function 102 is a set of output states 114. The elements of the set of input states 104 may be a set of strings of input bits of length n. Thus, the set of input states 104 may include a string of input bits 106. The term “string of input bits” may be used to refer any sequence of data bits utilized as an input parameter.

The elements of the set of output states 114 may be a set of strings of output bits of length m. Thus, the set of output states 114 may include a string of output bits 116. The target classical function 102 may map the domain (e.g., the set of input states 104) to the range (e.g., the set of output states 114). For instance, the target classical function 102 may map the string of input bits 106 to the string of output bits 116. Thus, the target classical function 102 is defined over the string of input bits 106.

The target classical function 102 may be decomposed into a set of parity sub-functions 108. The term “parity sub-function” may be used to refer to any mathematical or logical expression representing a combination, logic operation, or parity relationship (e.g., an exclusive OR sum) between two or more evaluations of a function.

Each parity sub-function of the set of parity sub-functions 108 may correspond to a parity of adjacent evaluations of the target classical function 102 obtained by fixing a string of most significant bits. The string of most significant bits may be a substring of the string of input bits. More specifically, each parity sub-function of the set of parity sub-functions 108 may be defined as an exclusive OR (XOR) sum of the target classical function 102 evaluated at a first input and the target classical function evaluated at a second input. The first and second inputs may differ by a specific value defined by a sequence of QROM operations 112.

The classical data loading pipeline 100 may include configuring a quantum circuit 110 to implement the target classical function 102. A set of quantum registers 120 of the QCS may be initialized with a superposition of input states 122 corresponding to the string of input bits 106. Subsequent to initializing the set of quantum registers 120, a sequence of Quantum Read-Only Memory (QROM) operations 112 may be executed, via the QCS, on the set of quantum registers 120. Each QROM operation of the sequence of QROM operations 112 may encode a separate parity sub-function of the set of parity sub-functions 108. More specifically, each QROM operation of the sequence of QROM operations 112 may act on a reduced number of input bits of the string of input bits 106 compared to a total number of input bits of the string of input bits 106 such that a gate count for each QROM operation is reduced. Executing the sequence of QROM operations 112 may generate a set of outputs 118.

Each output of the set of outputs 118 may be routed to a separate output register of a set of output registers 126 of the QCS. Routing each output of the set of outputs 118 may include employing a series of controlled swap gates 124 conditioned on the string of most significant bits to generate a set of parallel evaluations of the target classical function 102.

More specifically, a target classical function, which can encode classical data, may be expressed as mapping a string of input bits to output bits:
[symbol] (1)

To provide coherent access to the target classical function, the QCS can implement an oracle evaluating the target classical function:
[symbol] (2)

The target classical function may be decomposed into a set of parity sub-functions. In an embodiment, the QCS initializes the set of quantum registers with a superposition of input states corresponding to the string of input bits. The QCS executes a sequence of Quantum Read-Only Memory (QROM) operations on the set of quantum registers to generate a set of outputs. Each QROM operation of the sequence of QROM operations can encode a separate parity sub-function of the set of parity sub-functions. Subsequently, the QCS routes each output of the set of outputs to a separate output register of the set of output registers.

To facilitate the decomposition, a parameter may represent a substring size for a string of most significant bits, wherein the string of most significant bits forms a substring of the string of input bits. For indices, the QCS may define a family of functions ƒₗ representing the target classical function with a first k bits fixed:
[symbol] (3)

The QCS can further define a family of parity sub-functions. Each parity sub-function of the set of parity sub-functions may correspond to a parity of adjacent evaluations of the target classical function obtained by fixing the string of most significant bits:
[symbol] (4)

Equations combining the parity sub-functions can be evaluated by the QCS to reconstruct the original function:
[symbol] (5)

For inputs divided into most significant bits and remaining bits, the respective bitstrings may be represented as:
[symbol] (6)
[symbol] (7)

The QCS may act on a computational basis state, wherein and denote the string of most significant bits, and x_{R} and y_{R} denote remaining bits. Through this architecture, the QCS implements a circuit evaluating the target classical function on distinct inputs in parallel:
[symbol] (8)

For each parity sub-function, the QCS may implement a QROM operation acting as a data loading subroutine:
[symbol] (9)

Alternatively, the data loading subroutine may be executed utilizing a conditionally controlled state based on a control qubit:
[symbol] (10)

The set of quantum registers may include the control qubit and a set of input registers. In operation, the QCS routes each output by employing a series of controlled swap gates conditioned on the string of most significant bits to generate a set of parallel evaluations of the target classical function. For example, routing each output can comprise flipping the control qubit and swapping a first input register and a first output register based on a comparison between the string of most significant bits and an index associated with a current QROM operation. Prior to executing the sequence of QROM operations, the QCS may perform an initial inequality check on the string of input bits to enforce an ordering condition between portions of the string of input bits, such as confirming.

The QCS can route the inputs and outputs appropriately for each data lookup. The aggregate routing implementation may be characterized by
[symbol] (11)

When, the QCS may route inputs and outputs such that an effect of the QROM operation exclusively ORs into the register. This yields the modified state:
[symbol] (12)

Conversely, when, the QCS ensures exclusively ORs into the β register:
[symbol] (13)

By applying the identities of the parity sub-functions, the desired parallel evaluation circuit is successfully implemented. In some configurations, the QCS employs a SelectSwap quantum read-only memory (QROAM) circuit employing a set of ancilla qubits. An operation may implement a data lookup utilizing clean ancilla qubits:
[symbol] (14)

Prior to executing the sequence of QROM operations, the QCS can reset the set of ancilla qubits in a zero state of a computational basis. Subsequent to executing the sequence of QROM operations, and without performing a separate uncomputation step on the set of ancilla qubits, the QCS can reset the set of ancilla qubits to the zero state of the computational basis.

The QCS may execute the sequence of QROM operations by recursively applying a mass production protocol. The mass production protocol utilizes a first query protocol for generating a first number of queries as a subroutine to construct a second query protocol that generates a second number of queries, wherein the second number of queries is twice the first number of queries. Associated tuning parameters, such as a parameter, govern tradeoffs in the QROAM data lookups:
[symbol] (15)
[symbol] (16)
[symbol] (17)

To evaluate system performance, various embodiments may define an overall circuit cost based on a combination of Clifford gates and Toffoli gates:
[symbol] (18)

For a standard oracle operation, gate counts can be bounded by:
[symbol] (19)
[symbol] (20)
[symbol] (21)

By processing a reduced number of input bits, the overall gate count for the sequence of QROM operations is proportionately reduced. The total cost across the evaluation components can be determined as:
[symbol] (22)
[symbol] (23)
[symbol] (24)
[symbol] (25)

These bounds indicate that the total count of Clifford gates and Toffoli gates employed to generate the set of outputs scales asymptotically with a cost of a single evaluation of the target classical function. Comparing the base cost relative to separated QROAM queries yields:
[symbol] (26)
[symbol] (27)
[symbol] (28)

Under the recursive mass production protocol, gate counts for generated subroutines scale predictably. For a given intermediate function, the counts are defined by:
[symbol] (29)
[symbol] (30)

Expanding to queries yields corresponding gate boundaries:
[symbol] (31)
[symbol] (32)

Asymptotic limit derivations for the implemented circuit demonstrate that performance is tightly bound as variables increase:
[symbol] (33)
[symbol] (34)
[symbol] (35)
[symbol] (36)
[symbol] (37)

An improvement factor parameter may be utilized to determine relative performance ratios for parallel queries:
[symbol] (38)

In addition to parallel evaluations, various embodiments can execute serial queries to the target classical function. The QCS may prepare a resource state including the superposition of input states entangled with a first output register containing evaluations of the target classical function:
[symbol] (39)

The QCS can consume the resource state to perform a serial query. The serial query can yield a first output corresponding to the target classical function exclusively ORed (XORed) with a random bitstring error:
[symbol] (40)

To recover an operation evaluating the target classical function without the random bitstring error, the expected execution may map as follows:
[symbol] (41)

To achieve this recovery, the QCS may apply a correction operation defined as the target classical function XORed with a shifted evaluation of the target classical function:
[symbol] (42)

The correction operation may include an additional QROM query:
[symbol] (43)

The correction function may be symmetric with respect to the random bitstring error, such that the correction operation incurs half a computational cost of a complete evaluation. The overall cost for sequential evaluations may scale dynamically based on a number of serial copies:
[symbol] (44)

When processing an arbitrary state of an input register, the QCS begins with a combined state:
[symbol] (45)

The QCS applies a series of CNOT gates from qubits of a first register to corresponding qubits of a second register, yielding an updated state:
[symbol] (46)

The QCS may perform a computational basis measurement of the second register. Assuming the random bitstring error is obtained, a post-measurement state can equal an expanded state:
[symbol] (47)

Discarding an unentangled input register containing the random bitstring error may yield the serial query applied to the arbitrary state. Assuming a first bit of the random bitstring error is 1, the QCS rewrites the state:
[symbol] (48)

To load the correction, the QCS may adjoin an ancilla input register and an additional ancilla qubit. The QCS utilizes a series of CNOT and X gates to load a new input register with a bitstring in an old input register XORed with the random bitstring error, and copies a first bit of the old input register into the additional ancilla qubit, yielding a modified state:
[symbol] (49)

Conditioned on the new ancilla qubit, the QCS may exchange the two input registers:
[symbol] (50)

The QCS executes a smaller QROM read to implement the correction operation utilizing a function acting on a reduced number of bits:
[symbol] (51)

The QCS acts on bits of a first input register together with the output register to obtain a corrected state:
[symbol] (52)

Uncomputing the swapping of the input registers, and uncomputing and discarding the ancilla registers, yields the fully recovered operation:
[symbol] (53)

In some instances, processing an arbitrary state of input and output registers is defined by:
[symbol] (54)

The QCS can reset the output register to a zero state, implementing a quantum channel:
[symbol] (55)

If an unconstrained operation is preferred over the quantum channel, the QCS may perform a lookup to an ancilla output register initialized in a zero state before XORing a result into an actual output register:
[symbol] (56)

In some embodiments, the target classical function may comprise a dataset for a quantum algorithm utilizing a linear combination of unitaries (LCU) formalism. Within this formalism, a target matrix representation may be block encoded:
[symbol] (57)
[symbol] (58)

The LCU decomposition evaluates as a linear combination of unitary elements:
[symbol] (59)

The target classical function encodes a set of coefficients for a state preparation subroutine (PREP) within the quantum algorithm:
[symbol] (60)
[symbol] (61)
[symbol] (62)

The target classical function can similarly encode data representing a quantum chemical Hamiltonian in a second quantization representation. By utilizing classical data loading steps within the PREP subroutine, the coefficients may be synthesized via coherent alias sampling:
[symbol] (63)
[symbol] (64)

The QCS can further apply amplitude amplification to the set of outputs to increase a probability of measuring a target state. A generalized target space formulation may demonstrate an arbitrary state separated into a targeted (“good”) subset and a rejected (“bad”) subset:
[symbol] (65)

Through parallel queries generated utilizing mass production, cost equality may maintain viability at high parallel scale thresholds:
[symbol] (66)

The amplitude amplification may act upon multiple copies of the target classical function generated in parallel:
[symbol] (67)

Aggregating the parallel evaluations into a unified probability domain may yield:
[symbol] (68)

Wherein the probability of observing the targeted subset may dynamically adjusts according to the number of instantiated instances:
[symbol] (69)

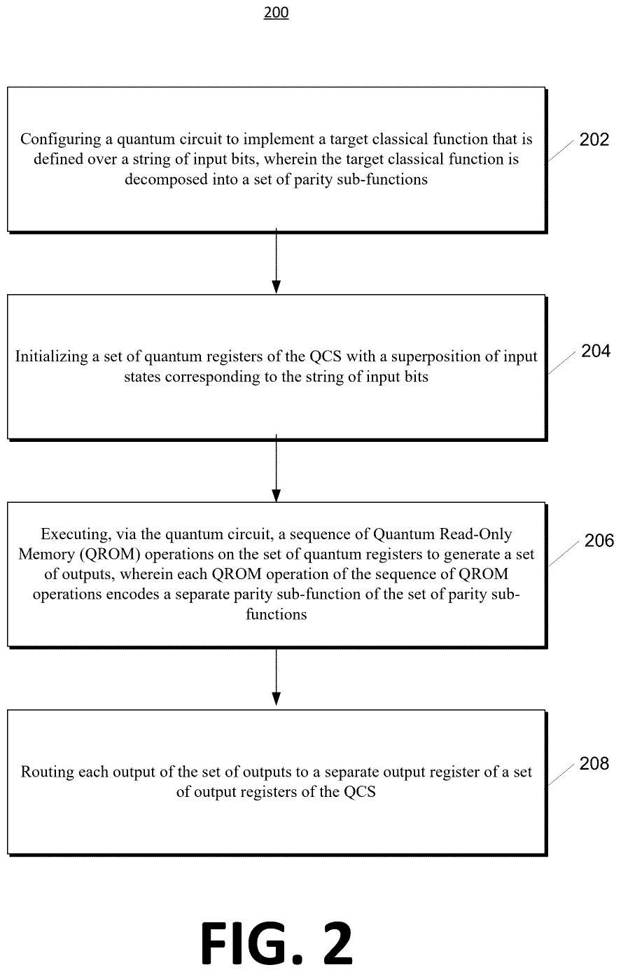

FIG. 2 depicts a flowchart of a method 200 for operating a quantum computing system (QCS) to load classical data, according to various embodiments. Method 200 begins at block 202, where a quantum circuit is configured to implement a target classical function that is defined over a string of input bits. The target classical function is decomposed into a set of parity sub-functions. At block 204, a set of quantum registers of the QCS is initialized with a superposition of input states corresponding to the string of input bits. At block 206, a sequence of Quantum Read-Only Memory (QROM) operations is executed, via the quantum circuit, on the set of quantum registers to generate a set of outputs. Each QROM operation of the sequence of QROM operations encodes a separate parity sub-function of the set of parity sub-functions. At block 208, each output of the set of outputs is routed to a separate output register of the set of output registers.

In some embodiments, each parity sub-function of the set of parity sub-functions corresponds to a parity of adjacent evaluations of the target classical function obtained by fixing a string of most significant bits. The string of most significant bits is a substring of the string of input bits.

In various embodiments, routing each output of the set of outputs includes employing a series of controlled swap gates conditioned on the string of most significant bits to generate a set of parallel evaluations of the target classical function.

In at least one embodiment, each parity sub-function of the set of parity sub-functions is defined as an exclusive OR (XOR) sum of the target classical function evaluated at a first input and the target classical function evaluated at a second input. The first and second inputs differ by a specific value defined by the sequence of QROM operations.

In some embodiments, each QROM operation of the sequence of QROM operations acts on a reduced number of input bits of the string of input bits compared to a total number of input bits of the string of input bits such that a gate count for each QROM operation is reduced.

In various embodiments, executing the sequence of QROM operations includes recursively applying a mass production protocol. A first query protocol for generating a first number of queries is utilized as a subroutine of the mass production protocol to construct a second query protocol that generates a second number of queries. The second number of queries is twice the first number of queries.

In at least one embodiment, the set of quantum registers includes a control qubit, a set of input registers that includes a first input register. The set of output registers includes a first output register. Routing each output includes flipping the control qubit and swapping the first input register and the first output register based on a comparison between a string of most significant bits and an index associated with a current QROM operation. The string of most significant bits is a substring of the string of input bits.

In some embodiments, executing the sequence of QROM operations includes utilizing a SelectSwap quantum read-only memory (QROAM) circuit that employs a set of ancilla qubits. Prior to executing the sequence of QROM operations, the set of ancilla qubits is reset in a zero state of a computational basis.

In various embodiments, method 200 further includes subsequent to executing the sequence of QROM operations and without performing a separate uncomputation step on the set of ancilla qubits, resetting the set of ancilla qubits to the zero state of the computational basis.

In at least one embodiment, the sequence of QROM operations and the routing of each output of the set of outputs are configured such that a total count of Clifford gates and Toffoli gates employed to generate the set of outputs scales asymptotically with a cost of a single evaluation of the target classical function.

In some embodiments, method 200 further includes prior to executing the sequence of QROM operations, performing an initial inequality check on the string of input bits to enforce an ordering condition between portions of the string of input bits.

In various embodiments, method 200 further includes preparing a resource state that includes the superposition of input states entangled with a first output register of the set of output registers. The first output register contains evaluations of the target classical function.

In at least one embodiment, method 200 further includes consuming the resource state to perform a serial query to the target classical function. The serial query yields a first output of the set of outputs. The first output corresponds to the target classical function exclusively ORed (XORed) with a random bitstring error.

In various embodiments, method 200 further includes applying a correction operation to the first output to remove the random bitstring error. The correction operation utilizes a correction function defined as the target classical function XORed with a shifted evaluation of the target classical function.

In at least one embodiment, the correction function is symmetric with respect to the random bitstring error, such that the correction operation employs half a computational cost of an evaluation of the target classical function.

In various embodiments, the target classical function includes a dataset for a quantum algorithm utilizing a linear combination of unitaries (LCU) formalism.

In such embodiments, the target classical function may encode a set of coefficients for a state preparation subroutine within the quantum algorithm.

In other embodiments, the target classical function encodes data representing a quantum chemical Hamiltonian in a second quantization representation.

In some embodiments, method 200 further includes applying amplitude amplification to the set of outputs to increase a probability of measuring a target state. The amplification amplitude acts upon multiple copies of the target classical function generated in parallel.

In at least one embodiment, executing the sequence of QROM operations includes sequentially applying a set of data lookups corresponding to the set of parity sub-functions. During sequentially applying the set of data lookups, a first data lookup of the set of data lookups is conditionally skipped based on a value of the string of input bits.

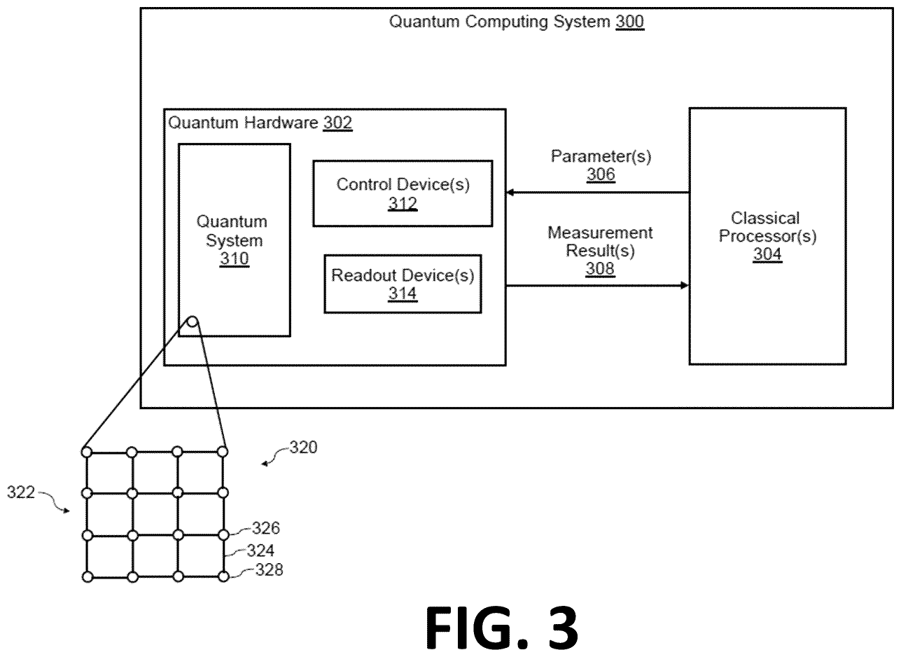

FIG. 3 depicts an example quantum computing system 300. The system 300 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 300 includes quantum hardware 302 in data communication with one or more classical processors 304. The classical processors 304 can be configured to execute computer-readable instructions stored in one or more memory devices to perform operations, such as any of the operations described herein. The quantum hardware 302 includes components for performing quantum computation. For example, the quantum hardware 302 includes a quantum system 310, control device(s) 312, and readout device(s) 314 (e.g., readout resonator(s)). The quantum system 310 can include one or more multi-level quantum subsystems, such as a register of qubits (e.g., qubits 320). In some implementations, the multi-level quantum subsystems can include superconducting qubits, such as flux qubits, charge qubits, transmon qubits, gmon qubits, spin-based qubits, and the like. In some implementations, the superconducting qubits may be located in a cryostat to cool the qubits to superconducting temperatures (e.g., less than about 3 Kelvin). However, aspects of the present disclosure are not limited to superconducting qubits. In some examples, any suitable qubit structure may be used without deviating from the scope of the present disclosure, such as photonic qubits, trapped ion qubits, spin qubits, neutral atom qubits, quantum dot qubits, molecular qubits, or other qubits.

The type of multi-level quantum subsystems that the system 300 utilizes may vary. For example, in some cases the system may include one or more readout device(s) 314 coupled (e.g., electromagnetically coupled) to one or more qubits, e.g., transmon, flux, gmon, xmon, or other qubits. In other cases, ion traps, photonic devices or superconducting cavities (e.g., with which states may be prepared without employing qubits) may be used. Further examples of realizations of multi-level quantum subsystems include fluxmon qubits, silicon quantum dot, or phosphorus impurity qubits.

Quantum-circuits may be constructed and applied to the register of qubits included in the quantum system 310 via multiple control lines that are coupled to one or more control devices 312. Example control devices 312 that operate on the register of qubits can be used to implement quantum gates or quantum-circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 312 may be configured to operate on the quantum system 310 through one or more respective control parameters (e.g., one or more physical control parameters). For example, in some implementations, the multi-level quantum subsystems may be superconducting qubits and the control devices 312 may be configured to provide control pulses to control lines to generate magnetic fields to control the qubits. For example, in some implementations the multi-level quantum subsystems may be neutral atom qubits and the control devices 312 may be configured to provide control pulses to control lines to generate magnetic fields to control the qubits. Neutral atom qubits can comprise arrays of single atoms, trapped and manipulated by focused laser beams called optical tweezers, as quantum bits (qubits). By exciting these atoms to high-energy Rydberg states, they interact over large distances to perform fast, high-fidelity quantum gates, with readout performed by detecting the internal quantum state (hyperfine or electronic levels) of individual atoms using fluorescence imaging or other suitable techniques.

The quantum hardware 302 may further include readout devices 314 (e.g., readout resonators). Measurement results 308 obtained via readout devices 314 may be provided to the classical processors 304 for processing and analyzing. In some implementations, the quantum hardware 302 may include a quantum-circuit and the control device(s) 312 and readout devices(s) 314 may implement one or more quantum logic gates that operate on the quantum system 310 through physical control parameters (e.g., microwave pulses) that are sent through wires included in the quantum hardware 302. The readout device(s) 314 may be configured to perform quantum measurements on the quantum system 310 and send measurement results 308 to the classical processors 304.

In addition, the quantum hardware 302 may be configured to receive data specifying physical control qubit parameter values 306 from the classical processors 304. The quantum hardware 302 may use the received physical control qubit parameter values 306 to update the action of the control device(s) 312 and readout devices(s) 314 on the quantum system 310. For example, the quantum hardware 302 may receive data specifying new values representing voltage strengths of one or more digital to analog converters (DACs) included in the control devices 312 and may update the action of the DACs on the quantum system 310 accordingly. The classical processors 304 may be configured to initialize the quantum system 310 in an initial quantum state, e.g., by sending data to the quantum hardware 302 specifying an initial set of parameters 306.

In some implementations, the readout device(s) 314 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 314 carries an amplitude and phase shift that depend on the qubit state. In some implementations, a Purcell filter can be used in conjunction with the readout device(s) 314 to impede microwave propagation at the qubit frequency.

In some embodiments, the quantum system 310 can include a plurality of qubits 320 arranged, for instance, in a two-dimensional grid 322. For clarity, the two-dimensional grid 322 depicted in FIG. 3 includes 4×4 qubits; however, in some implementations the quantum system 310 may include a smaller or a larger number of qubits. In some embodiments, the multiple qubits 320 can interact with each other through multiple qubit couplers, e.g., qubit coupler 324. The qubit couplers can define nearest neighbor interactions between the multiple qubits 320. In some implementations, the strengths of the multiple qubit couplers are tunable parameters. In some cases, the multiple qubit couplers included in the quantum computing system 300 may be couplers with a fixed coupling strength.

In some implementations, the multiple qubits 320 may include data qubits, such as qubit 326 and measurement qubits, such as qubit 328. A data qubit is a qubit that participates in a computation being performed by the system 300. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 320 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 320 can be chosen before a computation is performed. In some examples, operating on the frequencies for the qubits 320 may be adjusted using AC Stark shift according to examples of the present disclosure before a quantum computation, quantum gate, and/or a quantum algorithm is performed.

FIG. 3 depicts one example quantum computing system that can be used to implement the methods and operations according to example aspects of the present disclosure. Other quantum computing systems can be used without deviating from the scope of the present disclosure.

In various implementations, the example system 300 can be implemented as a client device, a server device, or both. The example system 300 can be implemented as part of a distributed computing system. The example system 300 can be implemented along with other example systems, which may be the same or different. The example system 300 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

Another embodiment includes a quantum computing system, such as but not limited to the quantum computing system 300 of FIG. 3. The QCS may include a set of quantum registers and a set of output registers. The QCS may further include one or more processing units and one or more memory devices. The one or more memory devices store computer-readable instructions. When the instructions are executed by the one or more processing units, the one or more processing units are caused to perform operations. The operations include configuring a quantum circuit to implement a target classical function that is defined over a string of input bits. The target classical function is decomposed into a set of parity sub-functions. The set of quantum registers is initialized with a superposition of input states corresponding to the string of input bits. A sequence of Quantum Read-Only Memory (QROM) operations is executed, via the quantum circuit, on the set of quantum registers to generate a set of outputs. Each QROM operation of the sequence of QROM operations encodes a separate parity sub-function of the set of parity sub-functions. Each output of the set of outputs is routed to a separate output register of the set of output registers.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses at least some quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states; however, it is understood that other setups where the computational states are identified with higher level excited states (e.g., qubits) are possible.

The term “data processing apparatus” refers to digital and/or quantum data processing hardware and encompasses at least some kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g., qubits. Generally, a digital data communication network does not transmit quantum data; however, a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g., photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include at least some forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood that such operations be performed in the particular order shown or in sequential order, or that at least some of the illustrated operations be performed, to achieve desirable results. In certain circumstances, multitasking and parallel processing may be advantageous. Moreover, the separation of various system modules and components in the implementations described above should not be understood as such separation in at least some implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures may not employ the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and at least some features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method for operating a quantum computing system (QCS) to load classical data, the method comprising:
configuring a quantum circuit to implement a target classical function that is defined over a string of input bits, wherein the target classical function is decomposed into a set of parity sub-functions;
initializing a set of quantum registers of the QCS with a superposition of input states corresponding to the string of input bits;
executing, via the quantum circuit, a sequence of Quantum Read-Only Memory (QROM) operations on the set of quantum registers to generate a set of outputs, wherein each QROM operation of the sequence of QROM operations encodes a separate parity sub-function of the set of parity sub-functions; and
routing each output of the set of outputs to a separate output register of a set of output registers of the QCS.

2. The method of claim 1, wherein each parity sub-function of the set of parity sub-functions corresponds to a parity of adjacent evaluations of the target classical function obtained by fixing a string of most significant bits, and wherein the string of most significant bits is a substring of the string of input bits.

3. The method of claim 2, wherein routing each output of the set of outputs includes employing a series of controlled swap gates conditioned on the string of most significant bits to generate a set of parallel evaluations of the target classical function.

4. The method of claim 1, wherein each parity sub-function of the set of parity sub-functions is defined as an exclusive OR (XOR) sum of the target classical function evaluated at a first input and the target classical function evaluated at a second input, wherein the first and second inputs differ by a specific value defined by the sequence of QROM operations.

5. The method of claim 1, wherein each QROM operation of the sequence of QROM operations acts on a reduced number of input bits of the string of input bits compared to a total number of input bits of the string of input bits such that a gate count for each QROM operation is reduced.

6. The method of claim 1, wherein executing the sequence of QROM operations comprises:
recursively applying a mass production protocol, wherein a first query protocol for generating a first number of queries is utilized as a subroutine of the mass production protocol to construct a second query protocol that generates a second number of queries, and the second number of queries is twice the first number of queries.

7. The method of claim 1, wherein the set of quantum registers includes a control qubit, a set of input registers that includes a first input register, and the set of output registers includes a first output register, and wherein routing each output comprises:
flipping the control qubit and swapping the first input register and the first output register based on a comparison between a string of most significant bits and an index associated with a current QROM operation, wherein the string of most significant bits is a substring of the string of input bits.

8. The method of claim 1, wherein executing the sequence of QROM operations comprises:
utilizing a SelectSwap quantum read-only memory (QROAM) circuit that employs a set of ancilla qubits, wherein prior to executing the sequence of QROM operations, the set of ancilla qubits is reset in a zero state of a computational basis.

9. The method of claim 8, further comprising:
subsequent to executing the sequence of QROM operations and without performing a separate uncomputation step on the set of ancilla qubits, resetting the set of ancilla qubits to the zero state of the computational basis.

10. The method of claim 1, wherein the sequence of QROM operations and the routing of each output of the set of outputs are configured such that a total count of Clifford gates and Toffoli gates employed to generate the set of outputs scales asymptotically with a cost of a single evaluation of the target classical function.

11. The method of claim 1, further comprising:
prior to executing the sequence of QROM operations, performing an initial inequality check on the string of input bits to enforce an ordering condition between portions of the string of input bits.

12. The method of claim 1, further comprising:
preparing a resource state that includes the superposition of input states entangled with a first output register of the set of output registers, wherein the first output register contains evaluations of the target classical function.

13. The method of claim 12, further comprising:
consuming the resource state to perform a serial query to the target classical function, wherein the serial query yields a first output of the set of outputs, wherein the first output corresponds to the target classical function exclusively ORed (XORed) with a random bitstring error.

14. The method of claim 13, further comprising:
applying a correction operation to the first output to remove the random bitstring error, wherein the correction operation utilizes a correction function defined as the target classical function XORed with a shifted evaluation of the target classical function.

15. The method of claim 14, wherein the correction function is symmetric with respect to the random bitstring error, such that the correction operation employs half a computational cost of an evaluation of the target classical function.

16. The method of claim 1, wherein the target classical function comprises a dataset for a quantum algorithm utilizing a linear combination of unitaries (LCU) formalism.

17. The method of claim 16, wherein the target classical function encodes a set of coefficients for a state preparation subroutine within the quantum algorithm.

18. The method of claim 1, wherein the target classical function encodes data representing a quantum chemical Hamiltonian in a second quantization representation.

19. The method of claim 1, further comprising:
applying amplitude amplification to the set of outputs to increase a probability of measuring a target state, wherein the amplitude amplification acts upon multiple copies of the target classical function generated in parallel.

20. The method of claim 1, wherein executing the sequence of QROM operations comprises:
sequentially applying a set of data lookups corresponding to the set of parity sub-functions, wherein during sequentially applying the set of data lookups, a first data lookup of the set of data lookups is conditionally skipped based on a value of the string of input bits.

21. A quantum computing system comprising:
a set of quantum registers;
a set of output registers;
one or more processing units;
one or more memory devices, the one or more memory devices storing computer-readable instructions that when executed by the one or more processing units cause the one or more processing units to perform operations comprising:
configuring a quantum circuit to implement a target classical function that is defined over a string of input bits, wherein the target classical function is decomposed into a set of parity sub-functions;
initializing the set of quantum registers with a superposition of input states corresponding to the string of input bits;
executing, via the quantum circuit, a sequence of Quantum Read-Only Memory (QROM) operations on the set of quantum registers to generate a set of outputs, wherein each QROM operation of the sequence of QROM operations encodes a separate parity sub-function of the set of parity sub-functions; and
routing each output of the set of outputs to a separate output register of the set of output registers.
